(19) United States
(12) Patent Application Publication
(10) Pub. No.: US 2005/0165124 A1
(43) Pub. Date: Jul. 28, 2005

(54) Polyurethane foams containing carbon black

(76) Inventor: Benjamin J. Brown, Yorkville, IL (US)

Correspondence Address: MCKELLAR IP LAW, PLLC, 784 SOUTH POSEYVILLE ROAD, MIDLAND, MI, 48640, US

(21) Appl. No.: 11/032,581

(22) Filed: Jan. 10, 2005

Related U.S. Application Data
(60) Provisional application No. 60/539,487, filed on Jan. 27, 2004.

(51) Int. Cl. C08G 18/00

(52) U.S. Cl. 521/155

(57) ABSTRACT

A process for preparing polyurethane foam by reacting an organic polyisocyanate with a polyol in the presence of a blowing agent and carbon black as well as a polyurethane foam containing carbon black.

### BACKGROUND

The instant invention relates to the preparation of polyurethane foams having improved flame retardant properties based on the inclusion of carbon black in the foam.

There are numerous approaches in the art to enhance the flame retardation properties of polymeric foams. A common approach for polyurethane foams is to include halogenated or phosphorous containing compounds in the composition. Another approach is the use of melamine as a flame retardant either alone or in combination with other flame retardants. Other approaches include changes in the molecular structure of the polymer, for example, polyisocyanurate formation or higher concentrations of aromatic units. Such approaches generally require relatively large amounts of the particular flame retardant. For example, U.S. Pat. No. 4,221,875 discloses the use of 20 to 100 parts of melamine powder per hundred parts of the polyhydroxyl compound. Another flame retardant which has been reported to give flame retardant properties to foams is expandable (exfoliating) graphite, see for example U.S. Pat. Nos. 4,698,369; 5,023,280; and 6,602,925.

Despite the abundance of disclosed processes to obtain flame retardant polyurethane foams, there continues to be a need to improve the fire retardant properties of such foams. Accordingly it is an object of the present invention to provide a process for preparing a flame-retardant polyurethane foam. It is a further objective of the present invention to produce such foams utilizing carbon black as the sole frame retardant agent as well as utilizing carbon black as a component of a flame retardant additive package. A further objective of the instant invention is to utilize carbon black recycled from used automobile tires.

### SUMMARY OF THE INVENTION

The instant invention is a process for preparing polyurethane foams by reacting an organic polyisocyanate with a polyol in the presence of a blowing agent and carbon black.

The instant invention is also directed to a polyurethane foam having 1-50 percent by weight of carbon black.

### DETAILED DESCRIPTION OF THE INVENTION

Polyisocyanates useful in making polyurethane foams for use in the instant invention include aliphatic and cycloaliphatic and preferably aromatic polyisocyanates or combinations thereof, advantageously having an average of from 2 to 3.5, and preferably from 2 to 3.2 isocyanate groups per molecule. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. The preferred polyisocyanates are aromatic polyisocyanates such as disclosed in U.S. Pat. No. 3,215,652.

Especially preferred polyisocyanates for use in the instant inventions are polymethylene polyphenylene polyisocyanates (MDI). As used herein MDI refers to polyisocyanates selected from diphenylmethane diisocyanate isomers, polyphenyl polymethylene polyisocyanates and derivatives thereof bearing at least two isocyanate groups. In addition to the isocyanate groups, such compounds may also contain carbodiimide groups, uretonimine groups, isocyanurate groups, urethane groups, allophanate groups, urea groups or biuret groups. MDI is obtainable by condensing aniline with formaldehyde, followed by phosgenation, which process yields what is called crude MDT. By fractionation of crude MDI, polymeric and pure MDI can be obtained. The crude, polymeric or pure MDI can be reacted with polyols or polyamines to yield modified MDT. The MDI advantageously has an average of from 2 to 3.5, and preferably from 2.0 to 3.2 isocyanate groups per molecule. Especially preferred are methylene-bridged polyphenyl polyisocyanates and mixtures thereof with crude diphenylmethane diisocyanate, due to their ability to cross-link the polyurethane.

The total amount of polyisocyanate used to prepare the polyurethane foam should be sufficient to provide an isocyanate reaction index of typically from 60 to 300. Preferably the index is greater than 70. More preferably the index is greater than 80. Preferably the index is no greater than 250. More preferably the index is no greater than 220. An isocyanate reaction index of 100 corresponds to one isocyanate group per isocyanate reactive hydrogen atom present from the water and the polyol composition.

Polyols that are useful in the preparation of the polyisocyanate-based cellular foams include those materials having two or more groups containing an active hydrogen atom capable of undergoing reaction with an isocyanate. Preferred among such compounds are materials having at least two hydroxyl, primary or secondary amine, carboxylic acid, or thiol groups per molecule. Compounds having at least two hydroxyl groups per molecule are especially preferred due to their desirable reactivity with polyisocyanates. Polyols derived from soybean oil are highly preferred in the instant invention.

Generally, typical polyols suitable for preparing polyurethanes include those having an average molecular weight of 100 to 10,000. Such polyols also advantageously have functionality of at least 2, preferably 3, and up to 6, preferably up to 8, active hydrogen atoms per molecule. For the production of a rigid foam, it is preferred that the polyol or a polyol blend have an average molecular weight of 100 to 2,000 and an average functionality of2 or greater, generally in the range of 2 to 8. More preferred are polyols or polyol blends that have an average molecular weight of 150 to 1,100.

Representative of polyols include polyether polyols, polyester polyols, polyhydroxy-terminated acetal resins, hydroxyl-terminated amines and polyamines. Examples of these and other suitable isocyanate reactive materials are described more fully in U.S. Pat. No. 4,394,491. Preferred are polyols prepared by adding an alkylene oxide, such as ethylene oxide, propylene oxide, butylene oxide or a combination thereof, to an initiator having from 2 to 6, preferably 3 to 4 active hydrogen atoms.

Due to the fire retardant properties associated with aromatic-initiated polyols, it is advantageous to use an aromatic-initiated polyether polyol as the polyol or part of a polyol blend. Further to the polyols described above, amine-initiated polyols can be used. Advantageously, the aromatic-initiated polyether polyol is an alkylene oxide adduct of a phenol/formaldehyde resin, frequently called a “novolac” polyol, such as disclosed in U.S. Pat. Nos. 3,470,118 and 4,046,721, or an alkylene oxide adduct of phenol/formaldehyde/alkanolamine resin, frequently called a “Mannich” polyol such as disclosed in U.S. Pat. Nos. 4,883,826; 4,939,182; and 5,120,815.

The fire retardant material used in the foams of the present invention is carbon black and preferably carbon black recycled from used automobile tires. The amount of carbon black used in the foams to give the desired physical properties is generally less than 50 percent by weight of the final foam. Preferably the amount of carbon black is 40 percent or less by weight of the final foam. More preferred is 30 percent or less by weight of carbon black in the final foam. Most preferred are foams that contain 20 percent or less by weight of carbon black. On the other hand, the amount of carbon black used in the foams to give the desired physical properties is generally more than 1 percent by weight of the final foam.

In accordance with this invention, the walls of the individual cells in the foams can be ruptured during the foaming process. The rupture of the cell walls is accomplished by the inclusion of a solid or liquid cell-opening agent. Such cell-opening agents are know in the art and are generally surface actives substances such as surfactants, fatty acid polyols or castor oil and modifications thereof and materials having a critical surface free energy of less than 23mJ/m.sup.2 as described in U.S. Pat. No. 5,312,846. A combination of these cell-opening agents may also be used.

Examples of surface-active substances include compounds that support the homogenization of the starting materials and are optionally also suitable for regulating cell structure. Examples include emulsifiers such as the sodium salts of fatty acids as well as salts of fatty acids with amines, for example, diethanolamine oleate, diethanolamine stearate, diethanolamine ricinoleate, salts of sulfonic acids, for example, alkali or ammonium salts of dodecylbenzenesulfonic acid or dinaphthylmethanedisulfonic acid and ricinoleic acid; foam stabilizers such as siloxane-oxyalkylene polymers or copolymers and other organopolysiloxanes, oxethylated alkyl phenols, oxethylated fatty alcohols, paraffin oils, castor oil and ricinoleic acid esters, turkey red oil and peanut oil; as well as cell regulators such as paraffins, fatty alcohols and dimethyl polysiloxanes. Furthermore, the oligomeric acrylates with polyoxyalkylene and fluoroalkane side groups are also suitable for improving the emulsifying effect, the cell structure and/or for stabilizing the foam. These surface-active substances are generally used in amount of 0.01 to 10 parts by weight based on 100 parts by weight of the polyol. Such materials are commercially available, for example, TEGOSTAB B8466, TEGOSTAB B8919, TEGOSTAB 8450, and ORTEGOL 501 from Th. Goldschmidt AG, and Surfactant 6164 from OSI Specialties-Witco.

It is preferred that the blowing agent consists essentially of water as the substantially sole blowing agent. The water reacts with isocyanate in the reaction mixture to form carbon dioxide gas, thus blowing the foam formulation. The amount of water added is generally in the range of 4 to 10 parts by weight per 100 parts by weight of polyol. Preferably water is added in the range of 4 to 8 parts, and more preferably from 5 to 7 parts per 100 parts of polyol. However, a volatile liquid such as a halogenated hydrocarbon or a low boiling hydrocarbon such as pentane and/or isomers thereof can also be used.

In addition to the foregoing components, it is often desirable to employ certain other ingredients in preparing cellular polymers. Among these additional ingredients are catalysts, surfactants, preservatives, colorants, antioxidants, reinforcing agents, cross-linker, chain extenders, stabilizers and fillers. In making polyurethane foam, it is generally highly preferred to employ a minor amount of a surfactant to stabilize the foaming reaction mixture until it cures. Such surfactants advantageously comprise a liquid or solid organosilicone surfactant. Other, less preferred surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 5 parts of the surfactant per 100 parts by weight polyol are sufficient for this purpose.

One or more catalysts for the reaction of the polyol (and water, if present) with the polyisocyanate are advantageously used. Any suitable urethane catalyst may be used, including tertiary amine compounds and organometallic compounds. Exemplary tertiary amine compounds include triethylenediamine, N-methyl morpholine, N,N -dimethyl cyclohexyl amine, penta-methyldiethylenetriamine, tetramethylethylenediamine, 1-methyl-4-dimethylaminoethylpiperazine, 3-methoxy-N-dimethylpropylamine, N-ethylmorpholine, diethylethanolamine, N-cocomorpholine, N,N-dimethyl-N′,N′-dimethylisopropylpropylene-diamine, N,N-diethyl-3-diethylaminopropylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-2-ethylhexanoate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. Such catalysts are used in an amount that measurably increases the rate of polyurethane or polyisocyanurate formation. Typical amounts are 0.001 to 5 parts of catalyst per 100 parts by weight of polyol. Preferred catalysts are those that contain one or more reactive hydrogen atoms.

Alternatively, other flame-retardant ingredients, known per se, may be used in addition to carbon black. Examples of such ingredients include halogen and/or phosphorous-containing compounds, antimony oxides, boron-containing compounds, or hydrated aluminas. Generally, when present the supplemental flame retardant will be added in an amount from 1 to 20 weight percent of the final foam. The addition of a supplemental flame retardant will influence the amount of carbon black that must be added to meet any specific test for flame retardancy.

The foams of the present invention generally have a density of 10 to 45 kg/cubic meter. Preferably the foams have a density of 15 to 35 kg/cubic meter.

In making polyurethane foam, the polyol(s), polyisocyanate, perforating agent and other components, including carbon black are contacted, thoroughly mixed and permitted to expand and cure into a cellular polymer. It is often convenient, but not necessary, to pre-blend certain of the raw materials prior to reacting the polyisocyanate and active hydrogen-containing components. For example, it is often useful to blend the polyol(s), blowing agent, surfactants, catalysts, perforating agent, carbon black and other components except for polyisocyanates, and then contact this mixture with the polyisocyanate. In a preferred embodiment, the carbon black is homogeneously dispersed in the polyol component. Alternatively, all components can be introduced individually to the mixing zone where the polyisocyanate and polyol(s) are contacted. In such a process, the dispersion of carbon black in Polyol may be added as a concentrate in the polyol by a separate line into the mixing zone. It is also possible to pre-react all or a portion of the polyol(s), in the absence of water, with the polyisocyanate to form a prepolymer.

The foams produced by the process of the instant invention can be used wherever desired. The foams of the instant invention are particularly applicable as thermal insulation materials and in seat cushions. The foams of the instant invention can be of the rigid or flexible variety and can be of the open cell or closed cell type.

The following examples are given to illustrate the invention and should not be interpreted as limiting it in anyway. Unless stated otherwise, all parts given are parts per hundred, by weight. The flame spread test used is Underwriters Laboratories test UL-94.

### COMPARATIVE EXAMPLE 1

A polyurethane foam is prepared by blending the following ingredients: 23.31 parts polyether polyol, 21.37 parts brominated diol flame retardant, 12.82 parts soy polyol, 23 parts water, 10 parts tris-chloropropyl phosphate flame retardant, 2 parts polyether/silicon oil cell opening agent, and 7.5 parts amine catalyst. The flame spread test indicated a flame spread of 10.25 inches. The flame produced black smoke.

### COMPARATIVE EXAMPLE 2

A polyurethane foam is prepared by blending the following ingredients: 23.31 parts polyether polyol, 16.37 parts brominated diol flame retardant, 29.19 parts soy polyol, 23parts water, 10 parts tris-chloropropyl phosphate flame retardant, 2 parts polyether/silicon oil cell opening agent, and 7.5 parts amine catalyst. The flame spread test indicated a flame spread of 18.46 inches. The flame produced heavy black smoke.

### EXAMPLE 1

A polyurethane foam is prepared by blending the following ingredients: 13.31 parts polyether polyol, 11.37 parts brominated diol flame retardant, 20 parts carbon black, 12.82 parts soy polyol, 23 parts water, 10 parts tris-chloropropyl phosphate flame retardant, 2 parts polyether/silicon oil cell opening agent, and 12 parts amine catalyst. The flame spread test indicated a flame spread of 11.75 inches. The flame produced lighter black smoke.

### EXAMPLE 2

A polyurethane foam is prepared by blending the following ingredients: 23.31 parts polyether polyol, 21.37 parts carbon black, 12.82 parts soy polyol, 23 parts water, 10 parts tris-chloropropyl phosphate flame retardant, 2 parts polyether/silicon oil cell opening agent, and 7.5 parts amine catalyst. The flame spread test indicated a flame spread of 10.34 inches. The flame produced light black smoke.

### EXAMPLE 3

A polyurethane foam is prepared by blending the following ingredients: 33.31 parts polyether polyol, 21.37 parts carbon black, 12.82 parts soy polyol, 23 parts water, 2 parts polyether/silicon oil cell opening agent, and 7.5 parts amine catalyst. The flame spread test indicated a flame spread of 10.81 inches. The flame produced medium black smoke.

The above examples show the surprising and very beneficial effect that carbon black has on the flame spread and smoke characteristics of a polyurethane foam.

1. A process for preparing polyurethane foam by reacting an organic polyisocyanate with a polyol in the presence of a blowing agent and carbon black.

2. The process of claim 1, wherein the polyurethane foam is a rigid foam.

3. The process of claim 1, wherein the polyurethane foam is a flexible foam.

4. The process of claim 1, wherein the polyurethane foam is a semi-rigid foam.

5. The process of claim 1, wherein the weight percent carbon black in the polyurethane foam is in the range of from 1-50 percent.

6. The process of claim 2, wherein the weight percent carbon black in the polyurethane foam is in the range of from 1-50 percent.

7. The process of claim 3, wherein the weight percent carbon black in the polyurethane foam is in the range of from 1-50 percent.

8. The process of claim 4, wherein the weight percent carbon black in the polyurethane foam is in the range of from 1-50 percent.

9. The process of claim 1, wherein the polyurethane foam is a closed cell foam.

10. The process of claim 2, wherein the polyurethane foam is a closed cell foam.

11. The process of claim 3, wherein the polyurethane foam is a closed cell foam.

12. The process of claim 4, wherein the polyurethane foam is a closed cell foam.

13. The process of claim 1, wherein the polyurethane foam is an open cell foam.

14. The process of claim 2, wherein the polyurethane foam is an open cell foam.

15. The process of claim 3, wherein the polyurethane foam is an open cell foam.

16. The process of claim 4, wherein the polyurethane foam is an open cell foam.

17. A polyurethane foam containing carbon black.

18. The polyurethane foam of claim 17, wherein the polyurethane foam is rigid.

19. The polyurethane foam of claim 17, wherein the polyurethane foam is flexible.

20. The polyurethane foam of claim 17 wherein the polyurethane foam is semi-rigid.

21. The polyurethane foam of claim 17, wherein the weight percent carbon black in the polyurethane foam is in the range of from 1-50 percent.

22. The polyurethane foam of claim 18, wherein the weight percent carbon black in the polyurethane foam is in the range of from 1-50 percent.

23. The polyurethane foam of claim 19, wherein the weight percent carbon black in the polyurethane foam is in the range of from 1-50 percent.

24. The polyurethane foam of claim 20, wherein the weight percent carbon black in the polyurethane foam is in the range of from 1-50 percent

25. The polyurethane foam of claim 17, wherein the polyurethane foam is a closed cell foam.

26. The polyurethane foam of claim 18, wherein the polyurethane foam is a closed cell foam.

27. The polyurethane foam of claim 19, wherein the polyurethane foam is a closed cell foam.

28. The polyurethane foam of claim 20, wherein the polyurethane foam is a closed cell foam.

29. The polyurethane foam of claim 17, wherein the polyurethane foam is an open cell foam.

30. The polyurethane foam of claim 18, wherein the polyurethane foam is an open cell foam.

31. The polyurethane foam of claim 19, wherein the polyurethane foam is an open cell foam.

32. The polyurethane foam of claim 20, wherein the polyurethane foam is an open cell foam.

33. The polyurethane foam of claim 21, wherein the polyurethane foam is an open cell foam.
